(19) United States
(12) Patent Application Publication
(10) Pub. No.: US 2005/0086321 A1
(43) Pub. Date: Apr. 21, 2005

(54) Apparatus and method for providing a virtual common hard disk recorder resource

(76) Inventor: Robert H. Folk II, Narberth, PA (US)

Correspondence Address: Caroline Coker;Motorola, Inc., 101 Tournament Drive, Horsham, PA, 19044, US

(21) Appl. No.: 10/690,053

(22) Filed: Oct. 21, 2003

(51) Int. Cl. G06F 15/167

(52) U.S. Cl. 709/213

(57) ABSTRACT

The present invention is a method of networking hard disk recorders to create a virtual common hard disk recorder resource. Two or more networked hard disk recorders are networked together to create a virtual hard disk recorder with the pooled capabilities of all networked hard disk recorders. To provide such pooled capabilities, the present invention provides for a virtual common writing feature, wherein each hard disk recorder may write content to any of the other networked hard disk recorders. The present invention also provides for a virtual common reading feature, wherein each hard disk recorder may write content to any of the other hard disk recorders.

### FIELD OF THE INVENTION

The present invention relates to the field of recording content, and more particularly, to a method of networking hard disk recorders to create a common resource for sharing and storing content.

### BACKGROUND OF THE INVENTION

A hard disk recorder, also known as a personal video recorder (PVR) or digital video recorder (DVR), is quickly becoming an entertainment staple in households. A hard disk recorder operates by utilizing a hard disk drive to record and playback television content. Hereinafter, the term “content” will be understood to include, but is not limited to, video on demand (VOD) content, near video on demand (NVOD) content, audio on demand content, Internet content, hard disk recorder content, and possibly other types of content yet to be discovered. With the popularity of these devices continuing to rise, the hard disk recorder is expected to make the VCR a device of the past.

As the hard disk recorder gains popularity, the chances of a household containing more than one hard disk recorder increases. For example, a household may have a first hard disk recorder for a living room television, and a second hard disk recorder coupled to a television in a bedroom. Multiple hard disk recorders located in one household, however, may prove problematic. For example, a user may record content onto a first hard disk recorder, but may later wish to view that content while watching the television coupled to a second hard disk recorder. In another situation, the user may want to setup a recording event while sitting at one television without interrupting what they are currently watching on that television. Yet, with current technology, there is not a mechanism to allow for these operations.

Such a mechanism for allowing such sharing between multiple hard disk recorders would be useful in a household comprising multiple hard disk recorders, because a user could record content onto one hard disk recorder regardless of whether the user wants to watch different content, then view the content from a television coupled to any hard disk recorder in the entire household. This mechanism would also be useful because users would not have to remember onto which particular hard disk recorder they recorded content. However, implementing such a mechanism becomes complicated concerning the storage of encrypted content onto one hard disk recorder, while using another hard disk recorder to access the encrypted content.

One possible option to overcome this complication includes storing content in a non-encrypted form, i.e., “in the clear” on the hard disk recorder recording the content (hereinafter referred to as the “first hard disk recorder”). This option would involve decrypting the encrypted content upon receipt by the first hard disk recorder, and storing the content in the first hard disk recorder in its non-encrypted form. However, this option is not desirable because content stored “in the clear” may permit unauthorized copying.

Another option may include simply storing the content in its original encrypted form on the first hard disk recorder. However, in this scenario, when another hard disk recorder networked to the first hard disk recorder (hereinafter referred to as the “second hard disk recorder”) needs to access the content, the second hard disk recorder must have the appropriate decryption keys received from the content source. While the decryption keys stored along with the content in the first hard disk recorder could be made available to the second hard disk recorder, this solution is problematic because the decryption keys expire after a certain amount of time.

Thus, there is a need in the art for a method of networking hard disk recorders to create a virtual common hard disk recorder resource so that a first hard disk recorder and a second hard disk recorder may seamlessly share content. There is also a need for a virtual common hard disk recorder resource wherein content may be shared between two or more hard disk recorders, while preserving the integrity and security of the content. Furthermore, there is also a need to provide such a virtual common storage resource wherein the content may be accessed regardless of the time elapsed after originally acquiring the content.

### SUMMARY OF THE INVENTION

Generally, the present invention is a method for networking hard disk recorders to create a virtual common hard disk recorder resource. More particularly, the present invention is a method of networking hard disk recorders to create a virtual common hard disk recorder resource that pools the capabilities and resources of all the networked hard disk recorders into one common resource available to all of the networked hard disk recorders. To provide the functionality of a single virtual hard disk recorder with the pooled capabilities of all the networked hard disk recorders, the present invention includes a virtual common writing feature and a virtual common reading feature. To provide such pooled capabilities, the present invention provides for a virtual common writing feature, wherein each hard disk recorder may write content to any of the other networked hard disk recorders. The present invention also provides for a virtual common reading feature, wherein each hard disk recorder may write content to any of the other hard disk recorders.

The foregoing and other objects, features, aspects and advantages of the present invention will become more apparent from the following detailed description of the present invention when taken in conjunction with the accompanying drawings.

### BRIEF DESCRIPTION OF THE DRAWINGS

For a fuller understanding of the present invention, reference is made to the following description taken in connection with the accompanying drawings, in which:

FIG. 1 is a simplified block diagram of an exemplary virtual common hard disk recorder resource in accordance with the present invention.

FIG. 2 is more detailed block diagram of a hard disk recorder included within the virtual common hard disk recorder resource in accordance with the present invention.

FIG. 3 is a flow diagram illustration of a method of storing content in accordance with the virtual common writing feature of the present invention from the perspective of the system.

FIG. 4 is a flow diagram illustration of a method of accessing content in accordance with the virtual common reading feature of the present invention.

### DETAILED DESCRIPTION

Reference will now be made in detail to the preferred embodiments of the present invention, examples of which are illustrated in the accompanying drawings. Generally, the present invention is a method for networking hard disk recorders to create a virtual common memory resource. More particularly, the present invention creates a virtual common hard disk recorder resource that pools the capabilities and resources of all the networked hard disk recorders into one common resource available to all of the networked hard disk recorders.

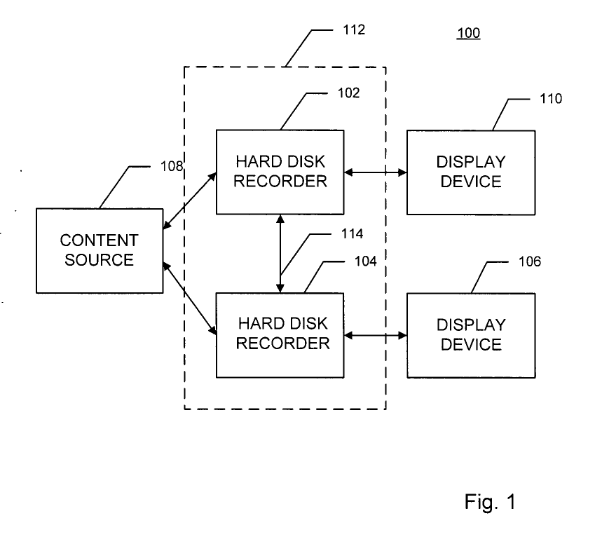

FIG. 1 is a simplified block diagram of an exemplary virtual common storage resource in accordance with the present invention. Exemplary system 100 has a content source 108, which may include, but is not limited to, a cable TV network, satellite TV system or broadcast television station. Content source 108 provides content to the virtual common hard disk recorder resource 112, which comprises individually, hard disk recorder 102 and hard disk recorder 104. hard disk recorder 102 and hard disk recorder 104 are devices that receive content from a content source and provide the content to a display device. A communication gateway 114 couples hard disk recorder 102 and hard disk recorder 104 to each other, enabling communication such as sharing tuning resources, encryption resources, and decryption resources. This communication gateway 114 may take any form capable of allowing such operations, including but not limited to, a wired or wireless connection. Those skilled in the art will appreciate that two hard disk recorders are shown in system 100 for exemplary purposes only, and system 100 may include any number of hard disk recorders without departing from the spirit or scope of the present invention. Furthermore, hard disk recorders 102 and 104 may exist externally, or internally, with respect to display devices 110 and 106 respectively.

hard disk recorder 102 and hard disk recorder 104 may supply content in real time from content source 108. Alternatively, hard disk recorder 102 and hard disk recorder 104 may supply content from an internal memory to display device 110 or 106, respectively, for viewing by a user. Display devices 110 and 106 may comprise any device capable of displaying content, including but not limited to television devices or computer devices.

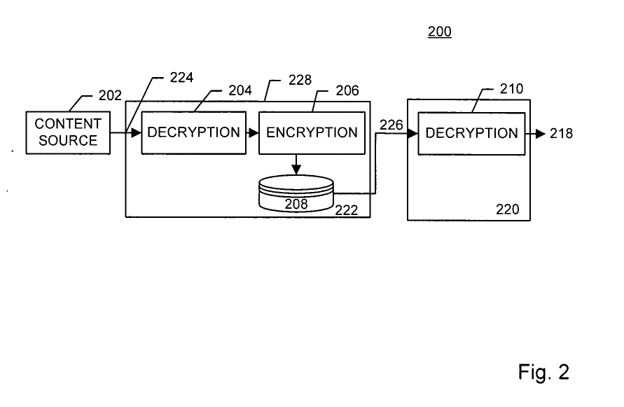

FIG. 2 is more detailed block diagram of a hard disk recorder included within the virtual common hard disk recorder resource in accordance with the present invention. Those skilled in the art will recognize that the virtual common hard disk recorder resource may include any number of networked hard disk recorders, and may also include components not shown in the figures.

Hard disk recorder 222 includes, among possibly other components, decryption unit 204, encryption unit 206, and database 208. In accordance with the virtual common writing feature of the present invention, the content source 202 communicates content, which may include but is not limited to, an encrypted MPEG stream, to the hard disk recorder 222. This encrypted content stream is received by a decryption unit 204 that performs the decryption function in a conventional manner, i.e. a decryption key is extracted from the content, and is utilized to effect the decryption. The decrypted content is then applied to the encryption device 206. The encryption device 206 encrypts the content via a local encryption scheme for transport to database 208, which may comprise any encryption scheme which ensures the security of the content.

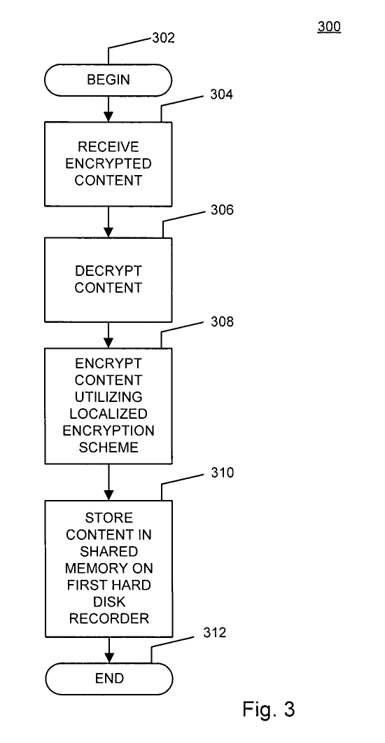

FIG. 3 is a flow diagram illustration of a method of storing content in accordance with the virtual common writing feature of the present invention from the perspective of the system. Method 300 begins at step 302 and proceeds to the receipt of encrypted content by the first hard disk recorder 222. The content originates from content source 202, and received by the first hard disk recorder via input device 224. This input device may include, but is not limited to, a port located on the first hard disk recorder 222.

At step 306, the first hard disk recorder decrypts the content received from the content source 202. The decryption of the content from the content source is performed in the conventional manner, by extracting a decryption key from the content, and utilized the decryption key to effect the decryption of the content.

At step 308, the content is encrypted utilizing a localized encryption scheme. The content is encrypted by communicating the content to the encryption device 206 located within the first hard disk recorder 222. The encryption device 206 then operates to encrypt the content via a series of instructions comprising the localized encryption scheme.

At step 310, the content is stored in a memory, such as a hard disk or other non-volatile memory, on the first hard disk recorder 102. Method 300 concludes at step 312 once the content is made available in the shared memory on the first hard disk recorder 102, in an encrypted form via the localized encryption scheme. Those skilled in the art will recognize that besides storing the content on the first hard disk recorder, the content can also be stored on any of the other hard disk recorders.

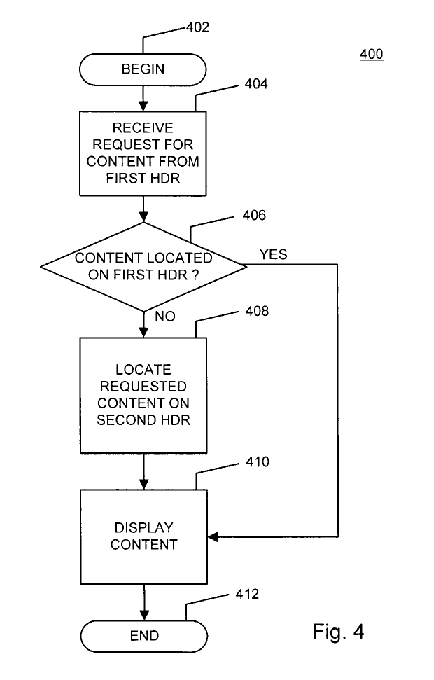

FIG. 4 is a flow diagram illustration of a method of accessing content in accordance with the virtual common reading feature of the present invention. Method 400 begins at step 402 and proceeds to the receipt of a request for content from the first hard disk recorder at step 404.

At step 406, the system determines if the content is located on the first hard disk recorder. If the content is located on the first hard disk recorder, method 400 proceeds to step 410, wherein the content is transmitted for display on display device 110 coupled to the first hard disk recorder 102.

If the content is not located on the first hard disk recorder 102, method 400 proceeds to step 408 to locate the requested content on the second hard disk recorder 104. Once the content is located on the second hard disk recorder 104, method 400 proceeds to step 410, wherein the content is displayed on the display device 110 coupled to the first hard disk recorder 102. This step involves either remotely accessing the content while stored in memory coupled to the first hard disk recorder 102, or transferring the content from the first hard disk recorder 102 to the second hard disk recorder 104.

The present invention is preferably implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, and additional operations can be added without departing from the invention. Such variations are contemplated and considered equivalent.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method of providing a virtual common reading feature for two or more networked hard disk recorders, said method comprising the steps of:
receiving a request to view content on a first hard disk recorder;
determining the requested content resides on a second hard disk recorder;
decrypting the requested content via a local encryption scheme; and
displaying the requested content on a display device coupled to the first hard disk recorder.

2. The method of claim 1, wherein displaying the requested content on a display device coupled to the first hard disk recorder comprises storing the requested content within a memory located within the first hard disk recorder.

3. The method of claim 1, wherein displaying the requested content on a display device coupled to the first hard disk recorder comprises remotely accessing the requested content on the first hard disk recorder.

4. A method of providing a virtual common writing feature to two or more networked hard disk recorders said method comprising the steps of:
receiving content on a first hard disk recorder from a content source;
decrypting the content;
re-encrypting the content utilizing a local encryption scheme; and
storing the content in a shared memory.

5. The method of claim 4, wherein decrypting the content comprises decrypting the content utilizing decryption keys received from the content source.

6. The method of claim 4, wherein storing the content in a shared memory comprises storing the content in a shared memory located within the first hard disk recorder.

7. The method of claim 4, wherein storing the content in a shared memory comprises storing the content in a shared memory located within a second hard disk recorder.

8. An apparatus providing shared tuning resources between two or more hard disk recorders, said apparatus comprising:
a network of hard disk recorders, said network of hard disk recorders comprising:
a first hard disk recorder, said first hard disk recorder comprising one or more tuners; and
a second hard disk recorder, said second hard disk recorder comprising one or more tuners;
a communication gateway coupling the first hard disk recorder to the second hard disk recorder;
an input from a content source; and
a program module, said program module containing instructions operative to:
determine the location of requested content on the network of hard disk recorders;
allocate tuning resources requested by a first hard disk recorder on the network of hard disk recorders;
allocate encryption resources requested by a first hard disk recorder on the network of hard disk recorders; and
allocate decryption resources requested by a first hard disk recorder on the network of hard disk recorders.

9. The apparatus of claim 8, wherein said network of hard disk recorders comprises a plurality of hard disk recorders.
